(19) United States
(12) Patent Application Publication
(10) Pub. No.: US 2026/0121227 A1
(43) Pub. Date: Apr. 30, 2026

(54) SEPARATOR FOR ELECTROCHEMICAL DEVICE AND ELECTROCHEMICAL DEVICE INCLUDING THE SAME

(71) Applicant: LG ENERGY SOLUTION, LTD., Seoul (KR)

(72) Inventors: Jin Young SHIN, Daejeon (KR); Kyung Ryun KA, Daejeon (KR); In Hyouk SUNG, Daejeon (KR); Hye Won KIM, Daejeon (KR); So Young YOON, Daejeon (KR)

(73) Assignee: LG ENERGY SOLUTION, LTD., Seoul (KR)

(21) Appl. No.: 19/367,022

(22) Filed: Oct. 23, 2025

(30) Foreign Application Priority Data
Oct. 24, 2024 (KR) 10-2024-0146492

(51) Int. Cl. H01M 50/451; H01M 10/052; H01M 50/42; H01M 50/429; H01M 50/44; H01M 50/491

(52) U.S. Cl. CPC H01M 50/451; H01M 10/052; H01M 50/42; H01M 50/4295; H01M 50/44; H01M 50/491

(57) ABSTRACT

A separator for an electrochemical device includes: a porous polymer substrate; and a coating layer provided on at least one surface of the porous polymer substrate, and including inorganic particles, a polymer binder, and nano fiber. The separator faces a dry positive electrode.

### CROSS REFERENCES TO RELATED APPLICATIONS

This application is based on and claims priority from Korean Patent Application No. 10-2024-0146492, filed on Oct. 24, 2024, with the Korean Intellectual Property Office, the disclosure of which is incorporated herein in its entirety by reference.

### TECHNICAL FIELD

The present disclosure relates to a separator for an electrochemical device, and an electrochemical device including the separator.

### BACKGROUND

An electrochemical device converts chemical energy into electrical energy using an electrochemical reaction, and recently, as one type of electrochemical devices, lithium secondary batteries have been widely used, which have high energy density and voltage, and extended cycle life, and are applicable in various fields.

A lithium secondary battery may include an electrode assembly fabricated by combining a positive electrode, a negative electrode, and a separator disposed between the positive electrode and the negative electrode, and may be manufactured by accommodating the electrode assembly in a case together with an electrolyte.

### SUMMARY

The present disclosure provides a separator for an electrochemical device, which exhibits excellent wettability and heat resistance, as a separator facing a dry positive electrode, and an electrochemical device with a low resistance and an improved cycle performance.

However, the effects achieved by the present disclosure are not limited to those described above, and other effects that are not described herein may be clearly understood by those skilled in the art from the following descriptions.

According to an embodiment of the present disclosure, a separator for an electrochemical device includes: a porous polymer substrate; and a coating layer provided on at least one surface of the porous polymer substrate, and including inorganic particles, a polymer binder, and nano fiber, wherein the separator faces a positive electrode of a dry type (a dry positive electrode).

The thickness of the porous polymer substrate may be about 10 μm or less.

The porosity of the porous polymer substrate may be about 60% or more.

The thickness of the coating layer may be about 0.5 μm to 3 μm.

The content of the inorganic particles may be about 70 parts by weight to 90 parts by weight based on 100 parts by weight of the coating layer.

The inorganic particles may include first inorganic particles and second inorganic particles.

The average particle diameter D50 of the first inorganic particles may be smaller than that of the second inorganic particles.

The ratio of the average particle diameter D50 of the first inorganic particles: the average particle diameter D50 of the second inorganic particles may be about 1:2 to 1:10.

The polymer binder may be an acrylic-based binder.

The nano fiber may be cellulose nano fiber.

The content of the nano fiber may be about 10 parts by weight to 20 parts by weight based on 100 parts by weight of the coating layer.

The dry positive electrode includes a positive electrode active material, and the positive electrode active material may include an LFP (lithium iron phosphate)-based active material.

According to another embodiment of the present disclosure, an electrochemical device includes: a dry positive electrode; a negative electrode; and the above-described separator disposed between the dry positive electrode and the negative electrode.

The separator for an electrochemical device according to an embodiment of the present disclosure is a separator facing a dry positive electrode, which may improve the wettability and the heat resistance.

The electrochemical device according to an embodiment of the present disclosure may achieve the low resistance and the improved cycle performance, by introducing the dry positive electrode and the separator with the improved wettability and heat resistance.

### BRIEF DESCRIPTION OF THE DRAWINGS

The drawings attached herewith are merely illustrative of embodiments of the present disclosure, and take on the role of further facilitating the understanding of the technical idea of the present disclosure along with the descriptions herein. Thus, the present disclosure should not be construed as being limited to those illustrated in the drawings.

FIG. 1 is a schematic view of a separator for an electrochemical device according to an embodiment of the present disclosure.

In some of the accompanying drawings, corresponding components will be denoted with the same reference numerals. The drawing FIGURES presented are illustrated for simplicity and clarity and have not necessarily been drawn to scale. For example, the dimensions of some of the elements in the FIGURES may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

In the descriptions herein below, when a certain part “includes” a specific component, this description does not indicate that the certain part excludes other components, but indicates that the part may further include other components, unless otherwise defined.

As used herein, the expression “A and/or B” indicates “A and B, or A or B.”

As used herein, the terms “about,” “approximately,” and “substantially” refer to a range of, or approximation to a numerical value or degree, taking into account inherent manufacturing and material tolerances (e.g., ±5%), and are intended to prevent infringers from unfairly taking advantage of the present disclosure that describes precise or absolute numerical values to aid the understanding of the present disclosure.

In the descriptions herein below, when a component is disposed “on” a specific part, this description does not exclude a case where another component is disposed between the component and the specific part, but indicates that another component may be further disposed therebetween, unless otherwise described.

In the descriptions herein below, when an object includes “pores,” this description indicates that the object has a plurality of pores connected to each other, and this structure may allow vapor and/or liquid fluids to pass through the pores from one side to the other side of the object.

In the descriptions herein below, a separator has porous characteristics, including a plurality of pores, and serves as a porous ion-conducting barrier that allows the passage of ions while blocking an electrical contact between the negative electrode and the positive electrode in an electrochemical device.

In the descriptions herein below, the “wet state” may refer to a state in which the separator is wetted with at least a portion of electrolyte, and the “dry state” may refer to a state in which the separator remains dry without being wetted with the electrolyte.

Of the components of an electrochemical device, an electrode of a dry type (a dry electrode) facilitates a high-loading coating as compared to an electrode of a wet type (a wet electrode), and therefore, enables adjustment of composition or arrangement of particles in each layer of the electrode, which is difficult to be implemented through a wet process, so that each layer may be designed to have a specific function, thereby contributing to rapid charging and extended lifespan. However, in the dry electrode, the wettability characteristics affected by the high loading needs to be taken into account. In the meantime, the dry electrode is manufactured by a direct coating of solid powder on a current collector without a solvent, and the wet electrode is manufactured by making the slurry using a solvent and coating the slurry on the current collector.

Meanwhile, of the components of an electrochemical device, a separator may include a porous polymer substrate disposed between the positive electrode and the negative electrode, and performs the role of separating the positive electrode and the negative electrode, and thus, preventing electrical short circuits between the two electrodes, while allowing passage of an electrolyte and ions. While the separator itself does not participate in electrochemical reactions, its physical properties such as wettability with electrolyte, porosity, and a thermal shrinkage rate, may affect the performance and safety of the electrochemical device.

In order to enhance the physical properties of the separator, various methods are being attempted, for example, forming a coating layer on the porous polymer substrate, and adding diverse substances to the coating layer to alter physical properties of the coating layer. For instance, inorganic substance may be added to the coating layer for the purpose of improving the mechanical strength of the separator, or inorganic substance or hydrate may be added to the coating layer for the purpose of improving fire resistance and heat resistance of the polymer substrate.

In the coating layer, inorganic particles are connected together by a polymer binder to form interstitial volumes, and lithium ions may move through the interstitial volumes. That is, the coating layer including the polymer binder and the inorganic particles serves not only to prevent the thermal shrinkage of the separator, but also to assist the migration of lithium ions through the separator.

In adopting the dry electrode, in order to improve the wettability characteristics affected by the high loading, it is also necessary to apply a separator with the excellent wettability characteristics, thereby contributing to reducing an activation process.

The present disclosure provides a separator that exhibits excellent wettability characteristics and achieves improved heat resistance.

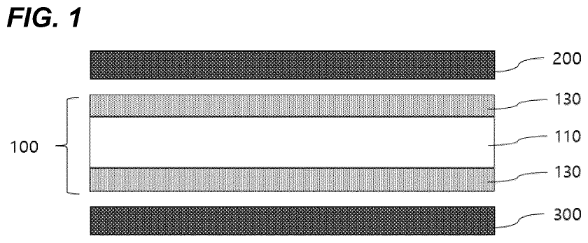

FIG. 1 is a schematic view of a separator for an electrochemical device according to an embodiment of the present disclosure.

An embodiment of the present disclosure provides a separator 100 for an electrochemical device. The separator 100 faces a dry positive electrode 200, and includes: a porous polymer substrate 110; and a coating layer 130 provided on at least one surface of the porous polymer substrate 110 and including inorganic particles, a polymer binder, and nano fiber.

The separator 100 for an electrochemical device according to an embodiment of the present disclosure is the separator 100 facing the dry positive electrode 200, and may improve the wettability and the heat resistance. Meanwhile, the separator 100 according to an embodiment of the present disclosure is not limited to the separator facing the dry positive electrode 200, and for example, the separator 100 of the present disclosure may face a wet positive electrode or a dry/wet negative electrode 300.

The separator 100 for an electrochemical device includes the porous polymer substrate 110. As described above, the separator 100 for an electrochemical device includes the porous polymer substrate 110, so that the separator 100 may allow the passage of lithium ions while blocking electrical contact, and may implement a shutdown function at an appropriate temperature. The “shutdown function” refers to a function of the separator 100 to block pores and cut off current flow, thereby preventing thermal runaway, when the battery overheats, which is a function that when the internal temperature of the battery rises to or above a specific temperature, the separator 100 melts and blocks the pores, thereby preventing the contact between the positive electrode 200 and the negative electrode 300 to stop the current flow.

According to an embodiment of the present disclosure, the porous polymer substrate 110 may be manufactured using a polyolefin-based resin as a base resin. Examples of the polyolefin-based resin include polyethylene, polypropylene, and polypentene, and at least one thereof may be included. The porous separator 100 manufactured using the polyolefin-based resin as a base resin, for example, the separator 100 having a plurality of pores may perform the shutdown function at an appropriate temperature.

According to an embodiment of the present disclosure, the weight-average molecular weight of the polyolefin-based resin may be about 500,000 to 1,500,000. By adjusting the weight-average molecular weight of the polyolefin-based resin in this range, the compression resistance of the separator 100 may be enhanced. Furthermore, when different types of polyolefin-based resins are blended together or are used to form the separator 100 with a multilayer structure, the weight-average molecular weight of the polyolefin-based resin may be calculated by summing the weight-average molecular weights of the individual polyolefin-based resins according to their respective content ratios.

In the descriptions herein, the weight-average molecular weight (Mw) may be measured by gel permeation chromatography (GPC, PL GPC220, Agilent Technologies, Inc.), and measurement conditions may be set as follows:
Column: PL Olexis (Polymer Laboratories, Ltd.)
Solvent: TCB (Trichlorobenzene)
Flow rate: 1.0 ml/min
Sample concentration: 1.0 mg/ml
Injection amount: 200 μl
Column temperature: 160° C.
Detector: Agilent High Temperature RI detector
Standard: Polystyrene (calibrated with a cubic function)

According to an embodiment of the present disclosure, the porous polymer substrate 110 may be manufactured using a method, in which the polyolefin-based resin is kneaded with a diluent at a high temperature to form a single phase, the polymer material and the diluent are subjected to phase separation through a cooling process, then, the diluent is extracted to form pores, and then, the polymer material is stretched and thermally secured (wet method).

According to an embodiment of the present disclosure, one of ordinary skill in the art may readily prepare the average size and the maximum size of the pores of the porous polymer substrate 110 to conform to the scope of the present disclosure, by adjusting, for example, the mixing ratio of the diluent, the stretching rate, and the temperature for the thermal securing process.

According to an embodiment of the present disclosure, the thickness of the porous polymer substrate 110 may be about 10 μm or less. For example, the thickness of the porous polymer substrate 110 may be about 3 μm to 10 μm, 4 μm to 10 μm, 5 μm to 10 μm, 6 μm to 10 μm, or 7 μm to 10 μm. In this thickness range, the function of the separator 100 may be enhanced, and the resistance increase and the capacity loss rate may be reduced. By adjusting the thickness of the porous polymer substrate 110 in the range described above, the energy density of the battery may be improved.

According to an embodiment of the present disclosure, the thickness of the porous polymer substrate 110 may be measured by a contact-based measurement method, using a thickness gauge (VL-50S-B, Mitutoyo Co.).

According to an embodiment of the present disclosure, the porosity of the porous polymer substrate 110 may be about 60% or more. For example, the porosity of the porous polymer substrate 110 may be about 60% to 70%. In this porosity range, the separator resistance and the cell initial resistance may be reduced, the capacity loss may decrease, and the mechanical strength of the separator 100 may be enhanced.

According to an embodiment of the present disclosure, the porosity refers to the ratio of the volume of pores to the volume of the separator 100, and may be measured according to ASTM D-2873.

According to an embodiment of the present disclosure, the coating layer 130 is provided on at least one surface of the porous polymer substrate 110. As described above, the separator 100 for an electrochemical device includes the coating layer 130 provided on at least one surface of the porous polymer substrate 110, so that the heat resistance and the mechanical properties of the separator 100 may be enhanced, and it is possible to prevent electrical short circuits at the electrodes resulting from the shrinkage of the separator 100 at a high temperature.

According to an embodiment of the present disclosure, the coating layer 130 includes inorganic particles, a polymer binder, and nano fiber. As described above, the coating layer 130 includes the inorganic particles, the polymer binder, and the nano fiber, so that the heat resistance and the mechanical properties of the separator 100 may be enhanced, it is possible to prevent electrical short circuits at the electrodes resulting from the shrinkage of the separator 100 at a high temperature, and pores may be formed inside the coating layer 130.

According to an embodiment of the present disclosure, the coating layer 130 may be formed in the manner that the inorganic particles are bound together by particles of the polymer binder and aggregated in the layer. The pores in the coating layer 130 may result from interstitial volumes that are voids among the inorganic particles.

According to an embodiment of the present disclosure, the coating layer 130 may include a plurality of pores. For example, the coating layer 130 may be a porous coating layer. According to an embodiment, the coating layer 130 may be a porous coating layer including a plurality of pores therein. As described above, the coating layer 130 includes the plurality of pores, so that the passage of lithium ions may be allowed to create a flow of current while physically separating the negative electrode 300 and the positive electrode 200.

According to an embodiment of the present disclosure, the thickness of the coating layer 130 may be about 0.5 μm to 3 μm. For example, the thickness of the coating layer 130 may be about 1 μm to 3 μm, or about 1 μm to 1.5 μm. In this thickness range, the coating may be performed smoothly, and the cell resistance may not significantly increase.

According to an embodiment of the present disclosure, the inorganic particles included in the coating layer 130 may be those in which oxidation and/or reduction reactions do not occur in an operation voltage range of an applied electrochemical device (e.g., 0 V to 5 V based on Li/Li+).

According to an embodiment of the present disclosure, the inorganic particles may be one or more selected from SiO₂, Al₂O₃, AlOOH, TiO₂, ZrO₂, BaSO₄, BaTiO₃, ZnO, MgO, Mg(OH)₂, Al(OH)₃, Pb(Zr,Ti)O₃, Pb(Mg_{1/3}Nb_{2/3})O₃—PbTiO₃(PMN-PT), HfO₂, SrTiO₃, SnO₂, CeO₂, MgO, NiO, CaO, Y₂O₃, SiC, ZnSn(OH)₆, Zn₂SnO₄, ZnSnO₃, Sb₂O₃, Sb₂O₄, and Sb₂O₅. The inorganic particles may be Al₂O₃.

According to an embodiment of the present disclosure, the content of the inorganic particles may be about 70 parts by weight to 90 parts by weight based on 100 parts by weight of the coating layer 130. For example, the content of the inorganic particles may be about 74 parts by weight to 84 parts by weight based on 100 parts by weight of the coating layer 130. By adjusting the content of the inorganic particles as described above, the heat resistance of the separator 100 may be enhanced.

According to an embodiment of the present disclosure, the inorganic particles included in the coating layer 130 may include first inorganic particles and second inorganic particles. For example, the inorganic particles include the first inorganic particles and the second inorganic particles, which are different from each other, so that the thin-film coating and the heat resistance may be achieved, and the assembly processability may be improved. Meanwhile, when only the first inorganic particles are included, the assembly processability may deteriorate due to low roughness of the separator 100, and when only the second inorganic particles are included, the thin-film coating and the heat resistance may not be achieved.

According to an embodiment of the present disclosure, the content of the first inorganic particles may be about 50 parts by weight to 60 parts by weight based on 100 parts by weight of the coating layer 130. For example, the content of the first inorganic particles may be about 51 parts by weight to 59 parts by weight, or 52 parts by weight to 59 parts by weight, based on 100 parts by weight of the coating layer 130. By adjusting the content of the first inorganic particles in this range, the thin-film coating and the heat resistance may be achieved, and the assembly processability may be improved.

According to an embodiment of the present disclosure, the content of the second inorganic particles may be about 20 parts by weight to 30 parts by weight based on 100 parts by weight of the coating layer 130. For example, the content of the second inorganic particles may be about 21 parts by weight to 28 parts by weight, or 22 parts by weight to 25 parts by weight, based on 100 parts by weight of the coating layer 130. By adjusting the content of the second inorganic particles in this range, the thin-film coating and the heat resistance may be achieved, and the assembly processability may be improved.

According to an embodiment of the present disclosure, the average particle diameter D50 of the first inorganic particles may be smaller than the average particle diameter D50 of the second inorganic particles. When the average particle diameter D50 of the first inorganic particles is smaller than that of the second inorganic particles as described above, the thin-film coating and the heat resistance may be achieved, and the assembly processability may be improved.

According to an embodiment of the present disclosure, the ratio of the average particle diameter D50 of the first inorganic particles: the average particle diameter D50 of the second inorganic particles may be about 1:2 to 1:10. For example, the ratio of the average particle diameter D50 of the first inorganic particles: the average particle diameter D50 of the second inorganic particles may be about 1:3 to 1:9, 1:4 to 1:8, or 1:5 to 1:7. In this range for the average particle diameter ratio, it is possible to prevent the average particle diameter D50 of the second inorganic particles from becoming excessively large, which may result in deterioration of the heat-resistance characteristics of the separator 100, and it is possible to prevent the decrease in roughness of the separator 100, which may result in deterioration of the assembly processability. By adjusting the ratio between the average particle diameter D50 of the first inorganic particles and the average particle diameter D50 of the second inorganic particles in the range above, the thin-film coating and the heat resistance may be achieved, and the assembly processability may be improved.

In the descriptions herein, the “particle diameter D50” refers to the particle diameter at the 50% point in the cumulative distribution of the number of particles according to particle diameters. The particle diameter may be measured using a laser diffraction method. For example, powder to be measured is dispersed in a dispersion medium, and then, introduced into a commercially available instrument for laser diffraction particle diameter measurement (e.g., Microtrac S3500) to measure a difference in diffraction patterns according to particle sizes when the particles pass through the laser beam, and calculate a particle diameter distribution. With the measurement instrument, the particle diameter D50 may be measured by calculating the particle diameter at the point corresponding to 50% of the cumulative distribution of the number of particles according to particle diameters.

According to an embodiment of the present disclosure, the polymer binder included in the coating layer 130 may be an acrylic-based binder, a polyvinylidene-based binder, or a combination thereof. The combination of the acrylic-based binder and the polyvinylidene-based binder may be a mixture of the acrylic-based binder and the polyvinylidene-based binder, a copolymer including acrylic repeating units and polyvinylidene repeating units, or a hybrid of the acrylic-based binder and the polyvinylidene-based binder. The polyvinylidene-based binder may be a copolymer of polyvinylidene fluoride (PVdF) and hexafluoropropylene (HFP). By selecting the polymer binder particles from the materials described above, the porosity of the separator 100 may be maintained, the adhesion between the electrode and the separator 100 during a lamination process for the battery may be enhanced, thereby facilitating the manufacture of the battery, and a stacking process may be stably implemented. Furthermore, the degree of porosity of the separator 100 may be maintained, and even when the coating layer is wetted with the electrolyte after activation of the battery, the adhesion may be maintained. Furthermore, the stiffness of the battery may be enhanced, and bending of the separator 100 may be prevented.

According to an embodiment of the present disclosure, the polyvinylidene-based binder may be a polyvinylidene-based binder in which the content of hexafluoropropylene (HFP) is about 1 wt % to 50 wt %. For example, in the polyvinylidene-based binder, the content of hexafluoropropylene (HEP) may be about 1 wt % to 50 wt %, 2 wt % to 45 wt %, 3 wt % to 40 wt %, 4 wt % to 35 wt %, 5 wt % to 30 wt %, 7 wt % to 25 wt %, or 10 wt % to 20 wt %. By selecting the polyvinylidene-based binder in which the content of hexafluoropropylene is 1 wt % to 50 wt % as described above, the degree of porosity of the separator 100 may be maintained, and even when the coating layer is wetted with the electrolyte after activation of the battery, the adhesion may be maintained. In the descriptions herein, the degree of substitution of the polyvinylidene-based binder may refer to the weight ratio of hexafluoropropylene contained therein.

According to an embodiment of the present disclosure, the polymer binder may be an acrylic-based binder. By selecting the acrylic-based binder as the polymer binder as described above, the binding force with the inorganic particles and the adhesion between the substrate and the electrode may be enhanced.

According to an embodiment of the present disclosure, the acrylic-based binder is a polymer including carboxylic acid ester as a repeating unit, and may be, for example, a (meth)acrylic acid ester or an acrylic-styrene copolymer.

According to an embodiment of the present disclosure, examples of the (meth)acrylic acid ester include (meth)acrylic acid methyl, (meth)acrylic acid ethyl, (meth)acrylic acid n-propyl, (meth)acrylic acid i-propyl, (meth)acrylic acid n-butyl, (meth)acrylic acid i-butyl, (meth)acrylic acid n-amyl, (meth)acrylic acid i-amyl, (meth)acrylic acid hexyl, (meth)acrylic acid cyclohexyl, (meth)acrylic acid 2-ethylhexyl, (meth)acrylic acid n-octyl, (meth)acrylic acid nonyl, (meth)acrylic acid decyl, (meth)acrylic acid hydroxymethyl, (meth)acrylic acid hydroxyethyl, (meth)acrylic acid ethylene glycol, di(meth)acrylic acid ethylene glycol, di(meth)acrylic acid propylene glycol, tris(meth)acrylic acid trimethylolpropane, tetra(meth)acrylic acid pentaerythritol, hexa(meth)acrylic acid dipentaerythritol, (meth)acrylic acid allyl, and di(meth)acrylic acid ethylene, and the (meth)acrylic acid ester may be at least one selected therefrom. The (meth)acrylic acid ester may be at least one selected from (meth)acrylic acid methyl, (meth)acrylic acid ethyl, and (meth)acrylic acid 2-ethylhexyl, and may be, for example, (meth)acrylic acid methyl.

According to an embodiment of the present disclosure, the acrylic-styrene copolymer may include an acrylic-based binder, and the acrylic-based binder may be a polyacrylate-based binder. For example, the binder may be at least one selected from styrene-butyl acrylate, a styrenebutadiene rubber, a nitril-butadiene rubber, an acrylonitrile-butadiene rubber, an acrylonitrile-butadiene-styrene rubber, and an acrylate-based polymer, and particularly, may be a copolymer including acrylate.

According to an embodiment of the present disclosure, the average particle diameter D50 of the polymer binder is not particularly limited, but may be in the range of about 0.1 μm to 1 μm in order to form the coating layer 130 having a uniform thickness and achieve the appropriate porosity. By adjusting the average particle diameter D50 of the polymer binder in the range above, the dispersibility in a slurry prepared for forming the coating layer may be improved, and the thickness of the resulting coating layer may be reduced.

According to an embodiment of the present disclosure, the content of the polymer binder included in the coating layer 130 may be about 1 parts by weight to 10 parts by weight based on 100 parts by weight of the coating layer 130. For example, the content of the polymer binder may be about 2 parts by weight to 9 parts by weight, 3 parts by weight to 8 parts by weight, 3 parts by weight to 7 parts by weight, 3 parts by weight to 6 parts by weight, or 3 parts by weight to 5 parts by weight, based on 100 parts by weight of the coating layer 130. In this range, it is possible to prevent or suppress the deterioration of heat resistance of the separator 100 caused by a decrease in parts by weight of the nano fiber or the inorganic substance, and to prevent or suppress the deterioration of coatability caused by an insufficient content of the polymer binder. In this way, by adjusting the content of the polymer binder in the range above, the ease of assembly during the process of assembling the electrodes may be improved.

According to an embodiment of the present disclosure, the nano fiber included in the coating layer 130 may be cellulose nano fiber. For example, the cellulose nano fiber is nano-sized fiber in which cellulose chains are bonded together as bundles, which is a material having an excellent tensile strength and a low density. When the cellulose nano fiber is used for the coating of the separator 100, the excellent mechanical properties may be achieved, and the separator 100 may be made thin easily. As described above, by including the cellulose nano fiber, excellent physical properties such as tensile strength and elastic modulus may be achieved despite the low density, and therefore, when the cellulose nano fiber is included in the coating layer 130, it may impart excellent mechanical strength even in a small amount. Further, the cellulose nano fiber is of the fiber bundle shape with the large surface area, which may improve the dispersibility of solid in a coating slurry. Further, the cellulose nano fiber may uniformly bind the inorganic particles in the coating layer 130, so that the coating layer 130 may be formed thin, achieving the thinning of the separator 100. Furthermore, since the cellulose nano fiber exhibits the excellent heat resistance, the thermal shrinkage phenomenon that may occur in the thin coating layer 130 may be mitigated.

According to an embodiment of the present disclosure, the content of the nano fiber may be about 10 parts by weight to 20 parts by weight based on 100 parts by weight of the coating layer 130. By adjusting the content of the nano fiber in this range, the heat resistance of the separator 100 may be improved.

An embodiment of the present disclosure includes an electrochemical device including: the dry positive electrode 200; the negative electrode 300; and the separator 100 for the electrochemical device described above, which is disposed between the dry positive electrode 200 and the negative electrode 300.

The electrochemical device according to an embodiment of the present disclosure adopts the dry positive electrode 200 and the separator 100 having the enhanced wettability and heat resistance, thereby achieving the low resistance and improving the cycle performance.

In the present disclosure, the electrochemical device refers to a device that converts chemical energy into electrical energy through an electrochemical reaction, and encompasses both primary batteries and secondary batteries. In the descriptions herein, the secondary battery is chargeable and dischargeable, and indicates batteries such as lithium secondary batteries, nickel-cadmium batteries, and nickel-hydrogen batteries. The lithium secondary batteries use lithium ions as ionic conductors, and examples thereof include non-aqueous electrolyte secondary batteries including a liquid electrolyte, all-solid-state batteries including a solid electrolyte, lithium polymer batteries including a gel polymer electrolyte, and lithium metal batteries using a lithium metal as the negative electrode 300, but are not limited thereto.

According to an embodiment of the present disclosure, the dry positive electrode 200 includes: a positive electrode collector; and a positive electrode active material layer including a positive electrode active material, a conductive material, and a binder resin on at least one surface of the collector. The positive electrode active material may include, for example, a lithium transition metal oxide; a lithium metal iron phosphate; a lithium nickel-manganese-cobalt oxide; a lithium nickel-manganese-cobalt oxide partially substituted with other transition metals; or two or more of the foregoing materials, but is not limited thereto. Examples of the positive electrode active material include layered compounds such as lithium cobalt oxides (e.g., LiCoO₂) and lithium nickel oxides (e.g., LiNiO₂), or compounds substituted with one or more transition metals; lithium manganese oxides such as compounds of the formula Li₁₊ₓMn₂₋ₓO₄ (where x is 0 to 0.33), LiMnO₃, LiMn₂O₃, and LiMnO₂; lithium copper oxides (e.g., Li₂CuO₂); vanadium oxides such as LiV₃O₈, LiV₃O₄, V₂O₅, and Cu₂V₂O₇, Ni-site lithium nickel oxides expressed by the formula LiNi₁₋ₓMₓO₂ (where M=Co, Mn, Al, Cu, Fe, Mg, B, or Ga, and x=0.01 to 0.3); lithium manganese complex oxides expressed by the formula LiMn₂₋ₓMₓO₂ (where M=Co, Ni, Fe, Cr, Zn, or Ta, and x=0.01 to 0.1) or Li₂Mn₃MO₈ (where M=Fe, Co, Ni, Cu, or Zn); lithium metal phosphate LiMPO₄ (where M=Fe, CO, Ni, or Mn), but are not limited thereto.

According to an embodiment of the present disclosure, the dry positive electrode 200 includes a positive electrode active material, and the positive electrode active material may include an LFP (lithium iron phosphate, LiFePO₄)-based active material. As described above, since the positive electrode active material includes the LFP (lithium iron phosphate, LiFePO₄)-based active material, the thermal stability may be enhanced as compared to an NCM (nickel-cobalt-manganese)-based active material, and the cycle life may be improved, so that the material may be more stably and continuously used. Further, since nickel is not included, stability is excellent, and since cobalt is not included, cost efficiency may be achieved.

According to an embodiment of the present disclosure, the negative electrode 300 included in the electrochemical device includes a negative electrode collector, and a negative electrode active material layer including a negative electrode active material, a conductive material, and a binder resin on at least one surface of the collector. The negative electrode 300 may include, as the negative electrode active material, one species or a mixture of two or more species selected from lithium metal oxides and carbon such as hard carbon and graphitic carbon; metal complex oxides such as LixFe₂O₃ (0≤x≤1), LiₓWO₂ (0≤x≤1), and SnₓMe₁₋ₓMe′_{y}O_{z} (Me: Mn, Fe, Pb, Ge; Me′: Al, B, P, Si; the elements of Groups 1, 2, 3 of the periodic table, halogen; 0<x≤1; 1≤y≤3; 1≤z≤8); lithium metals; lithium alloys; silicon-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; Li—Co—Ni-based materials; and titanium oxides.

According to an embodiment of the present disclosure, the conductive material included in the negative electrode 300 may be, for example, any one species or a mixture of two or more species selected from graphite, carbon black, carbon fiber or metal fiber, metal powder, conductive whisker, conductive metal oxides, activated carbon, and polyphenylene derivatives. Alternatively, the conductive material may be one species or a mixture of two or more species selected from natural graphite, artificial graphite, super-p, acetylene black, Ketjene black, channel black, furnace black, lamp black, thermal black, Denka black, aluminum powder, nickel powder, zinc oxide, potassium titanate, and titanium oxide.

According to an embodiment of the present disclosure, the collector included in the negative electrode 300 is not particularly limited as long as it has a high conductivity without causing chemical changes in the battery, and may be, for example, a stainless steel, copper, aluminum, nickel, titanium, calcined carbon, or aluminum or a stainless steel with its surface processed with carbon, nickel, titanium, silver or the like.

According to an embodiment of the present disclosure, the binder resin included in the negative electrode 300 may be a polymer conventionally used for electrodes in the related art. Non-limiting examples of the binder resin include polyvinylidene fluoride-co-hexafluoropropylene, polyvinylidene fluoride-cotrichloroethylene, polymethylmethacrylate, polyetylexyl acrylate, polybutylacrylate, polyacrylonitrile, polyvinylpyrrolidone, polyvinylacetate, polyethylene-co-vinyl acetate, polyethylene oxide, polyarylate, cellulose acetate, cellulose acetate butyrate, cellulose acetatepropionate, cyanoethylpullulan, cyanoethylpolyvinylalcohol, cyanoethylcellulose, cyanoethylsucrose, pullulan, and carboxyl methyl cellulose, but are not limited thereto.

According to an embodiment of the present disclosure, in the dry positive electrode 200, the binder is not particularly limited as long as it may fibrillize during a process of preparing a mixture lump. The “fibrillization” refers to a process of finely splitting a polymer, and may be performed using, for example, shear force. The polymer fiber obtained from the fibrillization has the surface that unravels, forming numerous fine fibers (fibrils).

Non-limiting examples of the binder polymer include polytetrafluoroethylene (PTFE), polyolefin, or a mixture thereof, and specifically, the binder polymer may include polytetrafluoroethylene (PTFE), and more specifically, may be polytetrafluoroethylene (PTFE). For example, the polytetrafluoroethylene (PTFE) may be included in an amount of 60 wt % or more based on the total weight of the binder polymer. Meanwhile, the material of the binder may further include one or more species among polyethylene oxide (PEO), polyvinylidene fluoride (PVdF), polyvinylidene fluoride-cohexafluoropropylene (PVdF-HFP), and polyolefin-based polymers.

According to an embodiment of the present disclosure, in preparing the dry positive electrode 200, the mixing of the electrode materials described above is performed such that the electrode active material, the binder polymer, and optionally, the conductive material are uniformly distributed, and since the components are mixed in powder form, the mixing may be performed by various methods without being limited as long as the components may be uniformly mixed. Since the mixing method is performed to prepare a dry electrode without using a solvent, the mixing may be performed through dry mixing, and may be performed by introducing the materials described above into a machine such as a blender or a super mixer.

According to an embodiment of the present disclosure, when a blender is used, the mixing may be performed in the blender at about 5,000 rpm to 20,000 rpm for 30 seconds to 20 minutes, for example, at about 10,000 rpm to 15,000 rpm for 30 seconds to 5 minutes, in order to ensure the uniformity.

A subsequent step may be performed, which kneads the mixture of the electrode materials at a high-temperature low shear rate to obtain a mixture lump.

This step is a step for fibrillizing the binder in the mixture prepared as described above, and is also referred to as a kneading process.

In an embodiment of the present disclosure, low-shear kneading may be performed to prevent excessive fibrillation of the binder, pulverization of the active material, and cutting of the formed fibers, but the kneading process is not limited thereto.

The kneading process may be performed using, for example, a kneader, but is not limited thereto.

The kneading process is a step in which the binder fibrillizes and binds or connects the active material and/or the conductive material particles, thereby forming a mixture lump with 100% solids.

In an embodiment of the present disclosure, the kneading process may be performed at a speed of about 10 rpm to 100 rpm for 1 minute to 30 minutes, and for example, at a speed of about 20 rpm to 50 rpm for 3 minutes to 10 minutes.

According to an embodiment of the present disclosure, the electrochemical device prepared as described above may be installed into an appropriate case, followed by injection of electrolyte, to manufacture a battery.

According to an embodiment of the present disclosure, the electrolyte may be, but not limited to, an electrolyte solution obtained by dissolving or dissociating a salt having, for example, the structure of A⁺B⁻ in an organic solvent, in which A⁺ includes ions consisting of alkali metal cations such as Li⁺, Na⁺, and K⁺, or combinations thereof, and B⁻ includes ions consisting of anions such as PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, and C(CF₂SO₂)₃⁻, or combinations thereof, and the organic solvent includes propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethylmethyl carbonate (EMC), gamma-butyrolactone (γ-butyrolactone), or a mixture thereof.

In an embodiment of the present disclosure, the external shape of the electrochemical device is not particularly limited, but may be a cylindrical shape using a can, a prismatic shape, a pouch shape, or a coin shape. Further, embodiments of the present disclosure provide a battery module that includes, as a unit battery, a battery including the electrochemical device described above, a battery pack including the battery module, and a device including the battery pack as a power source. Examples of the device include power tools driven by electric motors; electric vehicles (EV) including hybrid electric vehicles (HEV) and plug-in hybrid electric vehicles (PHEV); electric two-wheeled vehicles including electric bicycles (E-bikes) and electric scooters (E-scooters); an electric golf cart; and a power storage system, but are not limited thereto.

Hereinafter, the present disclosure will be further described in detail using Examples. However, Examples according to the present disclosure may be modified in various ways, and the scope of the present disclosure should not be construed as being limited to the Examples. The Examples are described below to more comprehensively describe the invention of the present disclosure to one having ordinary skill in the art.

### Preparation of Negative Electrode

A negative electrode active material (P20T/LSN-1, graphite):a binder (ADB22D, styrene butadiene rubber (SBR)-based polymer):a CMC aqueous solution (Daicel 2200, Daicel Chemical Industries, Ltd.):a conductive material (Super-C65, carbon black) were mixed with water at a weight ratio of 80.3/19.7:2.3:1.05:0.5, to prepare a slurry for a negative electrode active material layer, with a 50 wt % concentration of the components excluding water. Then, the slurry was applied to the surface of a copper thin film (thickness of 10 μm), and dried to prepare a negative electrode having the negative electrode active material layer (thickness of 120 μm).

### Preparation of Positive Electrode

### 1) Preparation of Wet Electrode

A positive electrode active material (S20, LFP):a conductive material (CNT (LB-CNT)):a binder (KF7200):a dispersant (HPD-01) were mixed with water at a weight ratio of 95.96:0.8:3.0:0.24, to prepare a slurry for a positive electrode active material layer, with a 50 wt % concentration of the components excluding water. Then, the slurry was applied to the surface of an aluminum thin film (thickness of 10 μm), and dried to prepare a wet positive electrode having the positive electrode active material layer (thickness of 120 μm).

### 2) Preparation of Dry Electrode

The positive electrode active material (S20, LFP):a conductive material (Li-435):a binder (PTFE) were introduced into a blender at a weight ratio of 94.0:1.5:4.5, and were mixed at 15,000 rpm for 1 minute, to obtain a mixture.

Then, the temperature of a kneader (e.g., Shin-il disperser) was stabilized to 150° C., and the obtained mixture was put into the kneader. Then, the kneader was operated at a speed of 40 rpm under a pressure of 1.1 atm for 5 minutes to obtain a mixture lump.

The mixture lump was put into a blender (Waring), and were crushed at 10,000 rpm for 1 minute to obtain electrode powder.

Then, the electrode powder was put into a lap calender (roll diameter: 160 mm, roll temperature: 100° C., 20 rpm), and a calendering process was repeated until the porosity became 35% or less. During the last calendering process, the pressure between rolls was set to 221 kg/cm to manufacture an electrode film. The manufactured electrode film had a thickness of 82 μm, the porosity of 31%, and the loading amount of 5.11 mAh/cm².

The electrode film was placed on the surface of a coated aluminum thin film (thickness: 10 μm), and subjected to lamination through lamination rolls maintained at 120° C., to manufacture a dry positive electrode.

### Manufacture of Separator and Electrochemical Device

### Example 1

### Preparation of Porous Polymer Substrate

A polyethylene resin (weight-average molecular weight: 1,000,000) was extruded and processed by a wet method to prepare a porous polymer substrate (thickness of about 10 μm, porosity of 60%).

### Formation of Coating Layer

Fumed-Al₂O₃ powder (Disperal 60, Sasol, Ltd.) with the average particle diameter D50 of 50 nm was prepared as first inorganic particles, and Al₂O₃ powder (A07, Alteo, Ltd.) with the average particle diameter D50 of 300 nm was prepared as second inorganic particles. An acrylic-based copolymer (CSB-140, Toyo Ink) was prepared as a polymer binder, cellulose nano fiber (CNF, Duracle A, Hansol Paper, Ltd.) was prepared, and sodium carboxymethyl cellulose (CMC-Na, SG-L02, GL Chem) was prepared as a dispersant.

The prepared first inorganic particles, second inorganic particles, polymer binder, nano fiber, and dispersant were added to water in a weight ratio of 56:24:4:14:2, and were dispersed to prepare a coating layer slurry with 20% solids.

The coating layer slurry was applied to both surfaces of the porous polymer substrate by a bar-coating method using a doctor blade, and was dried with 50° C. air using a heat gun to form coating layers each having a thickness of 1.0 μm on both surfaces of the porous polymer substrate.

### Preparation of Electrochemical Device

The prepared dry LFP positive electrode and the negative electrode were stacked with the separator of Example 1 interposed therebetween, and a lamination process was performed to obtain an electrochemical device. The lamination process was performed using a hot press under conditions of 60° C. and 6.5 MPa for 1 second.

### Example 2

The separator and the electrochemical device were manufactured in the same manner as in Example 1, except that the thickness of each coating layer was 1.5 μm.

### Example 3

The separator and the electrochemical device were manufactured in the same manner as in Example 1, except that the first inorganic particles, the second inorganic particles, the polymer binder, the nano fiber, and the dispersant were added to water in a weight ratio of 59:25:4:10:2, and were dispersed to prepare a coating layer slurry with 20% solids.

### Example 4

The separator and the electrochemical device were manufactured in the same manner as in Example 1, except that the first inorganic particles, the second inorganic particles, the polymer binder, the nano fiber, and the dispersant were added to water in a weight ratio of 52:22:4:20:2, and were dispersed to prepare a coating layer slurry with 20% solids.

### Example 5

The separator and the electrochemical device were manufactured in the same manner as in Example 1, except that the thickness of the porous polymer substrate was 7 μm.

### Example 6

The separator and the electrochemical device were manufactured in the same manner as in Example 1, except that the porosity of the porous polymer substrate was 70%.

### Comparative Example 1

The separator and the electrochemical device were manufactured in the same manner as in Example 1, except that the thickness of the porous polymer substrate was about 11 μm.

### Comparative Example 2

The separator and the electrochemical device were manufactured in the same manner as in Example 1, except that the porosity of the porous polymer substrate was 50%.

### Comparative Example 3

The separator and the electrochemical device were manufactured in the same manner as in Example 1, except that the thickness of the coating layer was 1.5 μm, and a single-sided coating was performed.

### Comparative Example 4

The separator and the electrochemical device were manufactured in the same manner as in Example 1, except that the porosity of the porous polymer substrate was 50%, the thickness of the coating layer was 1.5 μm, and a single-sided coating was performed.

### Comparative Example 5

### Preparation of Porous Polymer Substrate

A polyethylene resin (weight-average molecular weight: 1,000,000) was extruded and processed by a wet method to prepare a porous polymer substrate (thickness of about 10 μm, porosity of 60%).

### Formation of Coating Layer

Al₂O₃ powder (A07, Alteo, Ltd.) with an average particle diameter D50 of 300 nm was prepared as inorganic particles. An acrylic-based copolymer (CSB-140, Toyo Ink) was prepared as a polymer binder, and a PAA-based dispersant (CK-702) and a surfactant (BYK-348) were prepared.

The prepared inorganic particles, polymer binder, dispersant, and surfactant were added to water in a weight ratio of 95.4:2:2:0.6, and were dispersed to prepare a coating layer slurry with 35% solids.

The coating layer slurry was applied to both surfaces of the porous polymer substrate by a bar-coating method using a doctor blade, and was dried with 50° C. air using a heat gun to form coating layers each having a thickness of 1.0 μm on both surfaces of the porous polymer substrate.

### Preparation of Electrochemical Device

The prepared dry LFP positive electrode and the negative electrode were stacked with the separator of Example 5 interposed therebetween, and a lamination process was performed to obtain an electrochemical device. The lamination process was performed using a hot press under conditions of 60° C. and 6.5 MPa for 1 second.

### Comparative Example 6

The separator and the electrochemical device were manufactured in the same manner as in Comparative Example 5, except that the thickness of each coating layer was 1.5 μm.

### Comparative Example 7

The separator and the electrochemical device were manufactured in the same manner as in Comparative Example 5, except that the porosity of the porous polymer substrate was 50%, and the thickness of each coating layer was 1.5 μm.

### Comparative Example 8

The separator and the electrochemical device were manufactured in the same manner as in Example 1, except that a wet LFP positive electrode was used instead of the dry LFP positive electrode.

### Comparative Example 9

The separator and the electrochemical device were manufactured in the same manner as in Example 1, except that a wet LFP positive electrode was used instead of the dry LFP positive electrode, and the porosity of the porous polymer substrate was 50%.

### Comparative Example 10

The separator and the electrochemical device were manufactured in the same manner as in Comparative Example 5, except that a wet LFP positive electrode was used instead of the dry LFP positive electrode, and the thickness of each coating layer was 1.5 μm.

### Comparative Example 11

The separator and the electrochemical device were manufactured in the same manner as in Comparative Example 10, except that the porosity of the porous polymer substrate was 50%.

### Experimental Examples

Measurement of Wettability of Separator with Electrolyte

Propylene carbonate (PC, 2 μL) was dropped onto the surface of the separator in each of the Examples and the Comparative Examples. After 5 minutes, the spreading distance of the propylene carbonate at the droplet interface along both MD and TD directions (the distance from the droplet boundary to the outermost boundary) was measured, and the results are shown in Tables 1 and 2 below.

### Measurement of Dry Thermal Shrinkage of Separator at 180° C.

The separator of each of the Examples and the Comparative Examples was cut to prepare a sample measuring 5 cm×5 cm. The sample was placed in a convection oven at 180° C. for 30 minutes, and then, taken out of the oven, and the thermal shrinkage (%) in both the MD and TD directions was calculated according to [(initial sample length-length after the placement at 180° C. for 0.5 h)/(initial sample length)]×100(%). The results are shown in Tables 1 and 2 below.

### Measurement of Wet Thermal Shrinkage of Separator at 135° C.

The separator of each of the Examples and the Comparative Examples was cut to prepare a sample measuring 5 cm×5 cm, and a 9 cm×10 cm three-side sealed pouch was prepared.

The separator sample was put into the pouch, 1 g of the electrolyte described below was injected thereinto, and the pouch was sealed.

The electrolyte was obtained by adding 2 wt % vinylene carbonate (VC) and 1 M lithium salt LiPF₆ as additives to a solvent in which ethylene carbonate (EC) and ethyl methyl carbonate (EMC) were mixed in a weight ratio of 3:7. The sealed pouch was placed in a convection oven at 135° C. for 30 minutes, and then, the separator was taken out, to calculate the thermal shrinkage along both the MD and TD directions according to [(initial sample length-length after the placement at 180° C. for 0.5 h)/(initial sample length)]×100(%). The results are shown in Tables 1 and 2 below.

### Measurement of Resistance of Separator

A coin cell was manufactured by interposing the separator of each of the Examples and the Comparative Examples between SUS. An electrolyte, in which 1 M LiPF₆ was included, and ethylene carbonate and ethyl methyl carbonate were mixed at a volume ratio of 1:2, was injected into the coin cell. The resistance of the coin cell was measured from the results of electrochemical impedance spectroscopic analysis conducted using VMP3 of BioLogic Science Instrument under the conditions of amplitude of 10 mV and scan range of 0.1 Hz to 1 MHz at 25° C. The results are shown in Tables 1 and 2 below.

### Measurement of Initial Resistance of Electrochemical Device

After the electrochemical device of each of the Examples and the Comparative Examples was charged and discharged three times at 25° C. under a 0.33 C-rate condition, the resistance thereof was evaluated based on a resistance value measured when current was applied at 2.5 C-rate for 10 seconds at 50 SOC. The results are shown in Tables 1 and 2.

### Measurement of Initial Capacity and Capacity Loss Rate of Electrochemical Device

The electrochemical device of each of the Examples and the Comparative Examples was subjected to 100 charging/discharging cycles, each including charging to 4.2 V at 25° C. in a CC-CV mode at 1C, followed by discharging to 2.5 V at a constant current of 1C. Then, the initial capacity and the capacity loss rate were measured, to evaluate the life characteristics. The measurement results after 500 cycles are shown in Tables 1 and 2 below.

TABLE 1

| | | Ex. 1 | Ex. 2 | Ex. 3 | Ex. 4 | Ex. 5 | Ex. 6 |
|---|---|---|---|---|---|---|---|
| Positive electrode type | | Dry | Dry | Dry | Dry | Dry | Dry |
| Coating | Whether | Included | Included | Included | Included | Included | Included |
| layer | nano | | | | | | |
| composition | fiber is | | | | | | |
| | included | | | | | | |
| Thickness | Substrate | 10 | 10 | 10 | 10 | 7 | 10 |
| | Coating | 1/1 | 1.5/1.5 | 1/1 | 1/1 | 1/1 | 1/1 |
| | layer | | | | | | |

| | | | | | | |
|---|---|---|---|---|---|---|
| Porosity (%) | 60 | 60 | 60 | 60 | 60 | 70 |
| Separator wettability | 4.6/4.5 | 4.6/4.5 | 4.7/4.6 | 4.7/4.6 | 4.6/4.6 | 4.8/4.8 |
| (mm, MD/TD) | | | | | | |
| Dry thermal shrinkage | 1/1 | 1/1 | 1/1 | 1/1 | 2/2 | 2/2 |
| (%, MD/TD) | | | | | | |
| Wet thermal shrinkage | 3/2 | 2/2 | 2/2 | 2/2 | 5/5 | 2/2 |
| (%, MD/TD) | | | | | | |
| Separator resistance | 0.61 | 0.67 | 0.60 | 0.65 | 0.51 | 0.57 |
| (ohm) | | | | | | |
| Cell initial capacity | 40.8 | 40.5 | 40.9 | 40.7 | 40.8 | 40.8 |
| (mAh) | | | | | | |
| Cell initial capacity | 1.20 | 1.23 | 1.19 | 1.22 | 1.17 | 1.18 |
| (mohm) | | | | | | |
| Capacity loss rate (%) | 2.7 | 3.5 | 2.4 | 3.2 | 2.3 | 2.5 |

TABLE 2

| | | Comp. | Comp. | Comp. | Comp. | Comp. | Comp. |
|---|---|---|---|---|---|---|---|
| | | Ex. | Ex. | Ex. | Ex. | Ex. | Ex. |
| | | 1 | 2 | 3 | 4 | 5 | 6 |
| Positive | | Dry | Dry | Dry | Dry | Dry | Dry |
| electrode type | | | | | | | |
| Coating | Whether | Included | Included | Included | Included | Not | Not |
| layer | nano | | | | | included | included |
| composition | fiber is | | | | | | |
| | included | | | | | | |
| Thickness | Substrate | 11 | 10 | 10 | 10 | 10 | 10 |
| (μm) | Coating | 1/1 | 1/1 | Cross | Cross | 1/1 | 1.5/1.5 |
| | layer | | | section 1.5 | section 1.5 | | |

| Porosity (%) | | 60 | 50 | 60 | 50 | 60 | 60 |
|---|---|---|---|---|---|---|---|
| Separator | | 4.6/4.5 | 4.4/4.3 | 3.5/3.3 | 3.2/3.0 | 3.5/3.2 | 3.5/3.2 |
| wettability (mm, | | | | | | | |
| MD/TD) | | | | | | | |
| Dry thermal | | 1/0 | 1/0 | 60/62 | 60/60 | 14/10 | 3/2 |
| shrinkage (%, | | | | | | | |
| MD/TD) | | | | | | | |
| Wet thermal | | 2/2 | 2/2 | 25/23 | 22/20 | 17/15 | 10/8 |
| shrinkage (%, | | | | | | | |
| MD/TD) | | | | | | | |
| Separator | | 0.68 | 0.75 | 0.62 | 0.65 | 0.64 | 0.69 |
| resistance (ohm) | | | | | | | |
| Cell initial | | 39.8 | 39.2 | 39.5 | 39.3 | Not | 38.4 |
| capacity (mAh) | | | | | | evaluable | |
| Cell initial | | 1.25 | 1.32 | 1.27 | 1.30 | | 1.37 |
| capacity (mohm) | | | | | | | |
| Capacity loss | | 4.3 | 8.0 | 6.4 | 7.4 | | 10.2 |
| rate (%) | | | | | | | |
| | | | Comp. | Comp. | Comp. | Comp. | Comp. |
| | | | Ex. | Ex. | Ex. | Ex. | Ex. |
| | | | 7 | 8 | 9 | 10 | 11 |
| | Positive | | Dry | Wet | Wet | Wet | Wet |
| | electrode type | | | | | | |
| | Coating | Whether | Not | Included | Included | Not | Not |
| | layer | nano | included | | | included | included |
| | composition | fiber is | | | | | |
| | | included | | | | | |
| | Thickness | Substrate | 10 | 10 | 10 | 10 | 10 |
| | (μm) | Coating | 1.5/1.5 | 1/1 | 1/1 | 1.5/1.5 | 1.5/1.5 |
| | | layer | | | | | |

| | | | | | |
|---|---|---|---|---|---|
| Porosity (%) | 50 | 60 | 50 | 60 | 50 |
| Separator | 3.2/3.0 | 4.6/4.5 | 4.6/4.5 | 3.5/3.2 | 3.2/3.0 |
| wettability (mm, | | | | | |
| MD/TD) | | | | | |
| Dry thermal | 2/2 | 1/1 | 1/0 | 3/2 | 2/2 |
| shrinkage (%, | | | | | |
| MD/TD) | | | | | |
| Wet thermal | 8/4 | 3/2 | 2/2 | 8/7 | 9/6 |
| shrinkage (%, | | | | | |
| MD/TD) | | | | | |
| Separator | 0.78 | 0.62 | 0.68 | 0.69 | 0.78 |
| resistance (ohm) | | | | | |
| Cell initial | 38.0 | 39.0 | 38.7 | 39.5 | 39.0 |
| capacity (mAh) | | | | | |
| Cell initial | 1.40 | 1.32 | 1.35 | 1.36 | 1.39 |
| capacity (mohm) | | | | | |
| Capacity loss | 11.5 | 8.2 | 9.2 | 9.8 | 10.8 |
| rate (%) | | | | | |

According to Table 1 above, Examples 1 to 6 maintain the porosity of the separator substrate, which is a separator facing the dry positive electrode, at a high level of 60% to 70%, and include the nano fiber in the coating layer, so that the wettability is maintained at 4.6 mm (MD)/4.5 mm (TD) to 4.8 mm (MD)/4.8 mm (TD), and the thermal shrinkage is maintained at a relatively low level in both the dry state and the wet state, achieving the excellent heat resistance. Further, the separator resistance is relatively low in the range of 0.51Ω to 0.67Ω, and the capacity loss rate is also low in the range of 2.3% to 2.7%.

In contrast, in Comparative Example 1, as the thickness of the separator substrate increases to 11 μm, the separator resistance increases to 0.68Ω, compared to the Examples, and the capacity loss rate after 500 cycles slightly increases to 4.3%.

In Comparative Example 2, as the porosity of the porous polymer substrate decreases to 50%, the separator resistance increases to 0.75Ω, the cell initial resistance increases to 1.32 mΩ, and the capacity loss rate significantly increases to 8%.

In Comparative Examples 3 and 4, due to the single-sided coating of the coating layer, the wettability of the separator decreases to 3.5 mm/3.3 mm and 3.2 mm/3.0 mm, respectively, and the thermal shrinkage rate significantly increases in both the dry state and the wet state, and the capacity loss rate also significantly increases to 6.4% and 7.4%, respectively.

Meanwhile, in Comparative Example 5, when the coating layer does not include nano fiber, the content of the polymer binder is 2 parts by weight based on 100 parts by weight of the coating layer, and the thickness of each coating layer is 1 μm, uncoated regions are present due to the insufficient content of the binder.

In Comparative Examples 6 and 7, the coating layer does not include nano fiber, and in this case, as the heat resistance characteristics deteriorate, the thermal shrinkage in the wet state increases, the separator resistance increases to 0.69Ω and 0.78Ω, respectively, and the capacity loss rate also significantly increases to 10.2% and 11.5%, respectively.

In Comparative Examples 8 to 11, the wet positive electrode is used instead of the dry positive electrode, and in this case, the separator resistance is high in the range of 0.62Ω to 0.78Ω, and the capacity loss rate is also high in the range of 8.2% to 10.8%, which deteriorates the overall cell performance as compared to the Examples.

Therefore, the separator for an electrochemical device and an electrochemical device including the separator according to an embodiment of the present disclosure may enhance the wettability and the heat resistance by using the separator facing the dry positive electrode, and furthermore, may implement the electrochemical device with the low resistance and improved cycle performance.

While the embodiments of the present disclosure have been described, it will be appreciated by one of ordinary skill or knowledge in the art that the embodiments of the present disclosure may be changed or modified in various ways within the scope that does not depart from the technical scope of the various embodiments of the present disclosure defined in the claims attached herein below. Therefore, the technical scope of the various embodiments of the present disclosure is not limited to that in the Detailed Description section above, and may be defined by the claims.

What is claimed is:

1. A separator for an electrochemical device, the separator comprising:
a porous polymer substrate; and
a coating layer provided on at least one surface of the porous polymer substrate, and including inorganic particles, a polymer binder, and nano fiber,
wherein the separator faces a positive electrode of a dry type.

2. The separator according to claim 1, wherein a thickness of the porous polymer substrate is 10 μm or less.

3. The separator according to claim 1, wherein a porosity of the porous polymer substrate is 60% or more.

4. The separator according to claim 1, wherein a thickness of the coating layer is 0.5 μm to 3 μm.

5. The separator according to claim 1, wherein a content of the inorganic particles is 70 parts by weight to 90 parts by weight based on 100 parts by weight of the coating layer.

6. The separator according to claim 1, wherein the inorganic particles include first inorganic particles and second inorganic particles.

7. The separator according to claim 6, wherein an average particle diameter (D50) of the first inorganic particles is smaller than that of the second inorganic particles.

8. The separator according to claim 7, wherein a ratio of the average particle diameter (D50) of the first inorganic particles:the average particle diameter of the second inorganic particles is 1:2 to 1:10.

9. The separator according to claim 1, wherein the polymer binder is an acrylic-based binder.

10. The separator according to claim 1, wherein the nano fiber is cellulose nano fiber.

11. The separator according to claim 1, wherein a content of the nano fiber is 10 parts by weight to 20 parts by weight based on 100 parts by weight of the coating layer.

12. The separator according to claim 1, wherein the positive electrode of a dry type includes a positive electrode active material, and the positive electrode active material includes an LFP (lithium iron phosphate)-based active material.

13. An electrochemical device comprising:
a positive electrode of a dry type;
a negative electrode; and
the separator according to claim 1 disposed between the positive electrode of a dry type and the negative electrode.

14. The electrochemical device according to claim 13, wherein the electrochemical device is a lithium secondary battery.
